(19) United States
(12) Patent Application Publication
(10) Pub. No.: US 2025/0136301 A1
(43) Pub. Date: May 1, 2025

(54) Almanac of Neural Network Models

(71) Applicant: Advanced Space, LLC, Westminster, CO (US)

(72) Inventors: Nathan Parrish Ré, Billings, MT (US); Timothy M. Sullivan, Colorado Springs, CO (US); Kirk S. Roerig, Loveland, CO (US); Matthew D. Popplewell, Westminster, CO (US); Tyler M. Hanf, Broomfield, CO (US)

(21) Appl. No.: 18/932,120

(22) Filed: Oct. 30, 2024

Related U.S. Application Data
(60) Provisional application No. 63/594,182, filed on Oct. 30, 2023.

(51) Int. Cl. B64G 1/24; B64G 3/00; G01C 21/24

(52) U.S. Cl. CPC B64G 1/247; B64G 3/00; G01C 21/24

(57) ABSTRACT

An almanac method for autonomous neural network navigation of a spacecraft includes performing steps via a computer onboard the spacecraft for determining a current navigation state of the spacecraft and determining a current target epoch for the spacecraft based on the current navigation state. The method also includes reading neural network model parameters from an almanac for the current target epoch. The almanac contains a plurality of neural network models, with each model being valid for an epoch corresponding to a portion of a trajectory. The method further includes executing the neural network model corresponding to the current target epoch to provide one or more thrust commands for the spacecraft.

### CROSS-REFERENCE TO RELATED APPLICATIONS

This application claims the benefit of priority of U.S. Provisional Patent Application No. 63/594,182, entitled Almanac of Neural Network Models, and filed on Oct. 30, 2023, the disclosure of which is herein incorporated by reference in its entirety.

### BACKGROUND

### 1. Field

Embodiments of the invention relate generally to the field of space navigation systems, and more specifically to systems employing neural networks for optimizing navigation controls in space.

### 2. Related Art

Space navigation systems are an integral part of both manned and unmanned space flights since the inauguration of space missions in the 1960s. Space navigation requires complicated calculations, taking into account of not only the speed, the location, and the inertia of the spacecraft, but also the gravity field and many interspace perturbations from nearby planets and objects.

Multiple solutions have been provided for space navigation systems to determine commands to be executed by the spacecraft. For example, U.S. Patent Application Publication No. 2021/0364645 to Kim et al. discloses machine learning and neural networks for global positioning system (GPS) spoofing attack detection. International Publication No. WO2020247721 to Nair et al. discloses a method of measuring, modeling, and predicting the Earth's external magnetic field for improved georeferencing. U.S. Pat. No. 8,428,916 to Koller et al. discloses a method for modeling the Earth's radiation belt magnetosphere in decisional timeframes using neural network models. Non-patent literature to Rubinstein et al. (ScienceDirect, Vol. 176) discloses optimizing spacecraft trajectories using neural networks for autonomous navigation. Non-patent literature to Li et al. (IEEE Access, Vol. 7) discloses improving first guess costates for spacecraft navigation using neural networks. Non-patent literature to Zavoli et al. (arXiv, 2008.08501) discloses the use of Reinforcement Learning for the robust design of low-thrust interplanetary trajectories in presence of severe disturbances. Non-patent literature to Mereta et al. (HAIS 2017. Lecture Notes in Computer Science, Vol. 10334) discloses machine learning regressors to estimate the final spacecraft mass after an optimal low-thrust transfer between two Near Earth Objects.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In certain embodiments, an almanac method for autonomous neural network navigation of a spacecraft includes: providing autonomous neural network navigation of the spacecraft by performing steps via a computer onboard the spacecraft, the steps including: determining a current navigation state of the spacecraft; determining a current target epoch for the spacecraft based on the current navigation state; reading neural network model parameters from an almanac for the current target epoch, wherein the almanac contains a plurality of neural network models each valid for an epoch corresponding to a portion of a trajectory; and executing a neural network model of the plurality corresponding to the current target epoch to provide one or more thrust commands for the spacecraft.

In certain embodiments, a method for autonomous neural network navigation of a spacecraft includes: performing autonomous navigational steps via a computer onboard the spacecraft, the steps including: reading neural network model parameters from an almanac containing at least one neural network model, wherein each neural network model is valid for an epoch corresponding to a portion of a trajectory; determining a current navigation state of the spacecraft; determining a current target epoch for the spacecraft based on the current navigation state; and executing the neural network model corresponding to the current target epoch to provide one or more thrust commands for the spacecraft.

In certain embodiments, a computer program product for autonomous neural network navigation of a spacecraft is provided, the computer program product including a computer readable storage medium having computer readable instructions stored therein, wherein the computer readable instructions, when executed on a computing device, causes the computing device to: read neural network model parameters from an almanac containing at least one neural network model, wherein each neural network model is valid for an epoch corresponding to a portion of a trajectory; determine a current navigation state of the spacecraft; determine a current target epoch for the spacecraft based on the current navigation state; and execute the neural network model corresponding to the current target epoch to provide one or more thrust commands for the spacecraft.

### BRIEF DESCRIPTION OF THE DRAWING FIGURES

Embodiments of the invention are described in detail below with reference to the attached drawing figures, wherein:

FIG. 1A is a schematic diagram showing a ground-based control architecture for spacecraft navigation;

FIG. 1B is a schematic diagram showing an autonomous neural network control architecture for spacecraft navigation that takes place onboard the spacecraft, in an embodiment;

FIG. 2 is a schematic diagram showing steps of an autonomous neural network control method for spacecraft navigation having a safety check, in an embodiment;

FIG. 3A is a schematic diagram showing another embodiment of a time-ordered almanac method for autonomous neural network control for spacecraft navigation;

FIG. 3B is a schematic diagram showing another embodiment of a time-ordered almanac method for autonomous neural network control for spacecraft navigation;

FIG. 3C is a schematic diagram showing another embodiment of an almanac method for autonomous neural network control for spacecraft navigation;

FIG. 3D is a schematic diagram showing another embodiment of a time-ordered almanac method for autonomous neural network control for spacecraft navigation;

FIG. 3E is a schematic diagram showing another embodiment of an almanac method for autonomous neural network control for spacecraft navigation;

FIG. 3F is a schematic diagram showing a distance-ordered almanac method for use with a time-ordered almanac method for autonomous neural network control for spacecraft navigation, in an embodiment;

FIG. 4A is a flow diagram showing steps of a transfer method for autonomous neural network control for spacecraft navigation, in an embodiment;

FIG. 4B is a flow diagram showing the sub-steps from the transfer method of FIG. 4A; and

FIG. 5. is a table with descriptions of different neural network control for electric propulsion (NNEP) core Flight System (cFS) app states.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Space navigation requires accurately determining a spacecraft's trajectory periodically. Early trajectory determination techniques relied on optical tracking with telescopes. A single observation consists of two angular measurements (right ascension and declination). Therefore, a minimum of three measurements at three different epochs is required to provide six independent quantities required for a trajectory determination. Examples of optical tracking techniques include the method of Laplace, the method of Gauss, and the double r-iteration method.

Modern trajectory determination technologies depend on ground stations to pinpoint the position and movement of spacecraft. The ground stations use mechanisms such as radar, signal doppler, and laser reflectors to acquire orbital mechanics to calculate where the spacecraft is at a specific point in time. The orbital mechanics information is then compiled into an ephemeris table to calculate a precise position of the spacecraft. Other known remote sensing techniques can assist in space navigation by providing information in combination with the Global Navigation Satellite System (GNSS).

Spacecrafts are generally equipped with propulsion systems capable of providing small amounts of thrust for making orbital maneuvers. High thrust systems may operate for short bursts (seconds to minutes), while low thrust systems may operate over longer timeframes (days to weeks). For low thrust systems, small amounts of thrust may be applied over a significant fraction of a mission trajectory, which causes the optimal control problem (OCP) of shifting the spacecraft trajectory to be continuous rather than discrete, typically making the design of trajectories computationally more demanding.

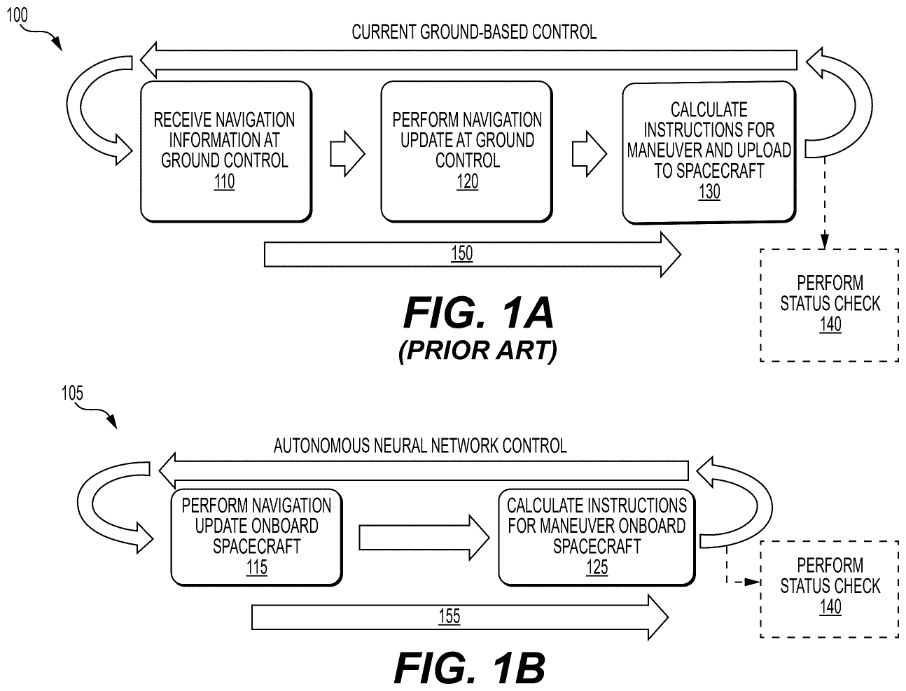

As illustrated in a schematic diagram of FIG. 1A, space missions are currently operated via a ground-based mission control center (MCC) using a ground-based control method 100. The MCC manages spaceflight operations from launch until landing or the end of the mission. A staff of flight controllers and other support personnel monitor all aspects of the mission using telemetry and sending commands to the spacecraft using ground stations. Personnel supporting the mission from an MCC can include representatives of the attitude control system, power, propulsion, thermal, attitude dynamics, orbital operations and other subsystem disciplines.

In a step 110, navigation information for the spacecraft is received at the MCC. In an example of step 110, the MCC receives navigation information about the spacecraft and determines a state (e.g., a position vector and a velocity vector) of the spacecraft.

In a step 120, a navigation update is performed at the MCC. In an example of step 120, the MCC predicts a next state of the spacecraft. For example, a position vector and velocity vector of the spacecraft is predicted for the next contact time with the spacecraft.

In a step 130, instructions for a maneuver are calculated and uploaded to the spacecraft. In an example of step 130, the MCC uploads commands from the ground control station to the spacecraft. The instructions may be for the spacecraft to coast or for the thrusters to execute a maneuver, for example.

In an optional step 140, a status check is performed. In an example of step 140, the ground team may perform periodic status checks on the spacecraft state.

Method 100 occurs over a timeframe 150. Timeframe 150 may be on the order of days to weeks due to the time lag for communicating with a distant spacecraft from the ground control station. The uncertainty of the spacecraft state increases with increasing timeframes.

Method 100 is then repeated by returning to step 110.

Long-distance communication between the ground-based MCCs and spacecraft far from Earth requires large and sensitive scientific telecommunications systems. For example, NASA's Deep Space Network (DSN) consists of three facilities spaced equidistant from each other—approximately 120 degrees apart in longitude—around the world. These sites are at Goldstone, near Barstow, California; near Madrid, Spain; and near Canberra, Australia. The strategic placement of these sites permits constant communication with spacecraft as our planet rotates—before a distant spacecraft sinks below the horizon at one DSN site, another site picks up the signal.

Each of the three DSN sites has multiple large antennas and is designed to enable continuous radio communication between several spacecraft and Earth. All three complexes consist of at least four antenna stations, each equipped with large parabolic dish antennas and ultra-sensitive receiving systems capable of detecting incredibly faint radio signals from distant spacecraft. For example, one of the massive antennas, located at NASA's Goldstone Deep Space Communications Complex in Barstow, California, is the 70-meter (330-foot) DSS-14 antenna. Each complex is situated in semi-mountainous, bowl-shaped terrains to shield against external radio frequency interference. For maintaining an effective long-distance communication, the DSN's large antennas have focusing mechanisms that concentrate power when receiving data and when transmitting commands. The antennas must point very accurately towards the spacecraft in a tiny portion of the sky. To hear the spacecraft's faint signal, the antennas must be equipped with amplifiers. However, there are two challenges. First, the signal becomes degraded by background radio noise, or static, emitted naturally by nearly all objects in the universe, including the sun and earth. The background noise gets amplified along with the signal. Second, the powerful electronic equipment amplifying the signal adds noise of its own. The DSN uses highly sophisticated technology, including cooling the amplifiers to a few degrees above absolute zero, and special techniques to encode signals so the receiving system can distinguish the signal from the unwanted noise. Antenna stations are remotely operated from a signal processing center at each complex. The centers house electronic systems that point and control the antennas, receive and process data, transmit commands and generate spacecraft navigation data.

The antennas of the Deep Space Network are the indispensable link to explorers venturing beyond Earth. Space mission operations teams use the DSN Command System to control the activities of their spacecraft. Commands are sent to robotic probes as coded computer files that the craft execute as a series of actions. The DSN Tracking System provides two-way communication between Earth-based equipment and a spacecraft, making measurements that allow flight controllers to determine the position and velocity of spacecraft with great precision. They provide the crucial connection for commanding our spacecraft and receiving their never-before-seen images and scientific information on Earth, propelling our understanding of the universe, our solar system and ultimately, our place within it. In addition to its vital role as the communications hub for deep space exploration, the DSN is also used as an advanced instrument for scientific research, including radio astronomy and radar mapping of passing asteroids.

As missions voyage further from Earth, it is important to continuously communicate with these spacecrafts and navigate them through space when they are so far from these ground-based control stations. In recent years, advanced spacecrafts have been designed and built to reach further away locations such as the Sun, Mercury, Mars, Jupiter and the Didymos asteroids-a trend that will continue into the years ahead. As such, a new challenge appears in view of this trend.

FIG. 1B illustrates an exemplary autonomous neural network control method 105 for autonomously controlling navigation of a spacecraft. In contrast to using ground-based control, which operates with outdated navigation data, the onboard autonomous control uses the latest navigation data in real-time or near real-time. Compared with ground-based control, onboard autonomous control may provide an immediate course correction. A neural network (NN) model approximates solutions to the optimal control problem with minimal computational overhead, operating as a feedback controller. The NN model is trained with a set of training data. For example, a “training tube” may be established around a nominal path for low-thrust trajectory corrections. In embodiments, the training tube refers to position and velocity errors around the nominal path. The NN model is then trained to respond to the position and velocity errors within the training tube and return the position and velocity values back to the nominal path values within a predetermined time frame Δt. In some embodiments, checkpoints are employed prior to especially sensitive parts of a trajectory (e.g., a flyby or other critical maneuver) to help ensure that the NN model can maintain the spacecraft path within the training tube. In certain embodiments, several NN models are trained, with each NN model being responsible for a section of a nominal transfer, which may produce better results compared to training one NN model over the entire transfer. Outputs of the one or more NN models may be compared to traditional methods (e.g., Monte Carlo simulations) to evaluate performance of the one or more NN models.

In a step 115, an onboard navigation update is performed. In an example of step 115, a computer onboard the spacecraft determines a state of the spacecraft (e.g., position, direction, and velocity of the spacecraft) and calculates navigation updates of the spacecraft state to predict a next state of the spacecraft (e.g., at a target epoch). In embodiments, the spacecraft may receive information for determining the state of the spacecraft from the Global Positioning System (GPS), the optical navigation system, or the Cislunar Autonomous Positioning System (CAPS), for example. In some embodiments, the onboard computer determines the spacecraft state based on an earlier navigation update. Alternatively, the spacecraft state may also be determined based on information from instruments onboard the spacecraft.

In a step 125, instructions for a maneuver are calculated onboard the spacecraft. In an example of step 125, a navigation state estimate is input to a NN model via an onboard computer, and maneuver instructions are output from the NN model.

In optional step 140, a status check is performed. In an example of step 140, the spacecraft onboard computer performs periodic status checks. The status check outcomes may be transmitted to a ground control station for monitoring.

Method 105 occurs over a timeframe 155. Timeframe 155 is on the order of minutes (e.g., ten minutes) due to the neural network calculations being performed locally on the spacecraft flight computer. Therefore, the spacecraft state remains accurate due to the short timeframe. The short timeframe also enables the spacecraft to make immediate course corrections whenever necessary. For a long duration maneuver (days to weeks), instructions for the next maneuver may be updated repeatedly on a shorter timeframe (e.g., every 5 to 10 minutes) while the maneuver is happening by using the NN model onboard the spacecraft.

Following step 125, method 105 is repeated by returning to step 115. Method 105 may be repeated at a more frequent rate compared with method 100 due to timeframe 155 being much shorter compared to timeframe 150.

Neural networks (NN), also known as artificial neural networks (ANNs) or simulated neural networks (SNNs), are a subset of machine learning algorithms. Their name and structure are inspired by the human brain, mimicking the way that biological neurons signal to one another. Artificial neural networks (ANNs) are comprised of a node of layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural network (NN) control provides a means for on-board maneuver correction without over-simplifying the calculations by learning the relationship between a spacecraft's state and an optimal maneuver to maintain an operational slot. The spacecraft's guidance and navigation system may evaluate the NN control in-flight, resulting in a reduction in operational costs and improvement in maneuver accuracy.

A neural network control for electric propulsion (NNEP) algorithm may be used with the following non-limiting examples: (1) application of NNEP algorithm to maneuver corrections for minimum-fuel transfers; (2): application of NNEP algorithm to GEO station keeping; (3) application of NNEP algorithm to Earth-Moon Halo Orbit station keeping; (4) application of NNEP algorithm to trajectory correction maneuvers for a chemical propulsion interplanetary mission; (5) application of NNEP algorithm to many-revolution spiral transfers; and (6) LEO station keeping. In embodiments, neural networks may also be used for missions with chemical propulsion, for large or small maneuvers, and for a range of dynamical environments including Earth orbit, the cislunar environment, and interplanetary space.

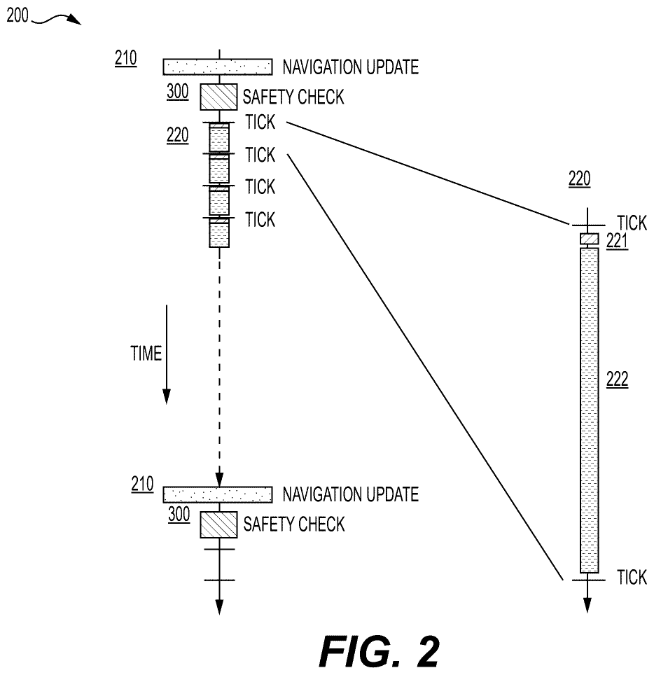

A method 200 is illustrated in FIG. 2 as a schematic diagram showing the steps of an exemplary concept of operations (ConOps) method for Optimal Low Thrust Artificial Intelligence Reoptimization (OLTAIR). The ConOps method for OLTAIR may be modified to suit particular mission constraints. Method 200 is an example of autonomous neural network control method 105 of FIG. 1B used for low-thrust maneuver correction. The ConOps method of OLTAIR comprises software, logically broken-up into two distinct sections: (1) Liboltair, which contains the platform-independent core autonomous trajectory correction logic; and (2) The cFS ecosystem, which contains all platform-specific functionality to use Liboltair in a flight-safe environment. Liboltair further includes a set of user-defined platform-specific interfaces, a generated ‘almanac’ containing a set of time dependent pre-trained neural network models, and the core logic to operate on the almanac and to utilize the interfaces as needed for autonomous trajectory corrections. Liboltair may operate through a single-entry point function known as the ‘tick’ function to avoid a control-loop specific design.

A navigation update 210 comprises a spacecraft computer receiving a navigation update and determines a current spacecraft state (e.g., state x″ (t), as described below. Navigation update 210 may be provided live by the Global Positioning System (GPS), the optical navigation system, or the Cislunar Autonomous Positioning System (CAPS). Alternatively, navigation update 210 may be a logical calculation based on an earlier live navigation update, or navigation update 210 may be acquired by instruments onboard the spacecraft.

Following navigation update 210, an exemplary neural network safety check method 300 may be performed. For example, an onboard computer may perform the neural network safety check method 300 to evaluate one or more ticks 220, prior to the spacecraft executing any tick function, as further described below. For example, method 300 may propagate NN model outputs immediately after they are generated and evaluate whether an expected final state is within a predetermined tolerance. If an evaluation by the neural network safety check method 300 passes, then method 200 executes the one or more ticks 220. An exemplary neural network safety check method is described in a co-pending U.S. patent application Ser. No. 18/664,743, filed May 15, 2024, and entitled Neural Network Safety Check, which is hereby incorporated by reference in its entirety.

Each tick 220 includes two separate maneuver types: a computer maneuver design 221 and a spacecraft maneuver 222. In embodiments, the computer maneuver design 221 performs the autonomous trajectory correction logic of Liboltair described above. The computer maneuver design 221 includes the following steps: 1) The computer checks the current state and estimates if a maneuver is needed in this step. If the maneuver is not needed in this step, the computer coasts to the next tick evaluation. If the maneuver is needed in this step, the computer performs the next computer maneuver step. 2) The computer identifies the relevant model weights to read from an almanac. The almanac is a collection structure of neural networks, which contains NN models and ancillary information. 3) The computer evaluates NN models to map a state estimate x^{→}(ti) to a maneuver Δv^{→}(ti). 4) The onboard propagator predicts a next state x^{→}(ti+1), assuming the spacecraft executes the commanded maneuver perfectly. 5) The computer increments to the next tick 220. It takes less than a second for the computer to perform the individual steps of the computer maneuver design 221. Executing the spacecraft maneuver 222 may take minutes or longer. Because the computer maneuver design 221 is performed much more quickly than the spacecraft maneuver 222, the neural network safety check method 300 is able to execute a series of steps of the computer maneuver design 221 without performing the spacecraft maneuver 222 and evaluate the spacecraft commands and outcomes much faster than, and prior to, the real-time execution of the spacecraft maneuver 222. Following a successful evaluation by the NN safety check method 300, the spacecraft maneuver 222 may then be executed. Once the spacecraft executes a commanded thrust, it then coasts until the next tick 220. One or more ticks 220 may be performed until the spacecraft computer receives a next set of navigation updates 210. The spacecraft computer then repeats the NN safety check method 300 and one or more ticks 220 in another cycle.

A working example of a neural network model is the application of neural network control for electric propulsion (NNEP) in 3-Body orbits. The reliability of the NN model has been tested at the following three levels: 1) the NN is automatically demonstrated with every code version submitted to a version control system, which verifies that the NN output vector matches expected values when provided with a given set of weight parameters and a given input vector; and, 2) the NN is tested via Monte Carlo trials on ground computers, which includes randomly sampling an expected distribution of spacecraft states for which the NN should be valid, evaluating the NN on each of those states, and propagating the output to the target epoch. Monte Carlo ground testing verifies that the NN training did not overfit the training data and that the NN is accurate for flight operations. If the NN is found to be inaccurate, a smaller NN model may be used, which provides more robust but less precise outputs, and/or more training samples may be generated for the NN model. The testing provides information as to how a spacecraft responds to stressing situations prior to uploading the NN to the spacecraft. (3) The NNEP technology has reliability built into its architecture. For example, the flight software (FSW) propagates the NN outputs immediately after they are generated, evaluating whether the expected final state is within tolerance and whether path constraints (e.g., eclipses or close approaches to other bodies) are met.

Historically, achieving a 2-day navigation and control update loop with human-in-the-loop control has required 24-hr coverage from operations teams and is only practical for short periods of critical operations. In contrast, once a state estimate is available for NNEP, thruster commands may be provided immediately, drastically reducing the time of the navigation and control update loop, while also automating the process. When the thruster is throttled smoothly, the NN model output is virtually indistinguishable from a perfect, ground-generated solution.

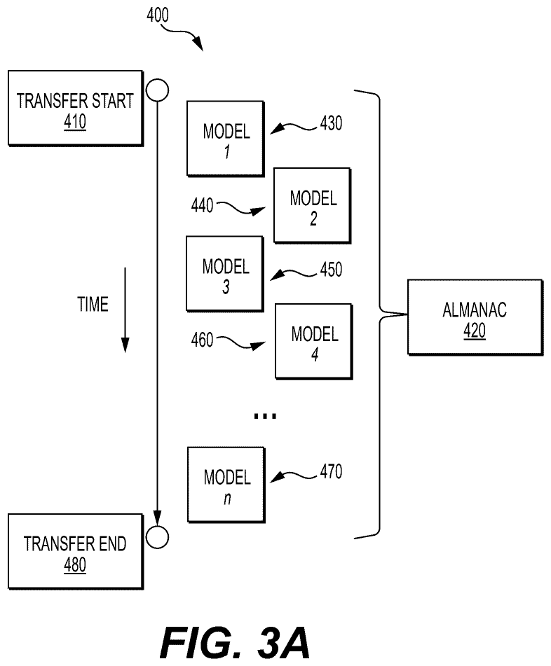

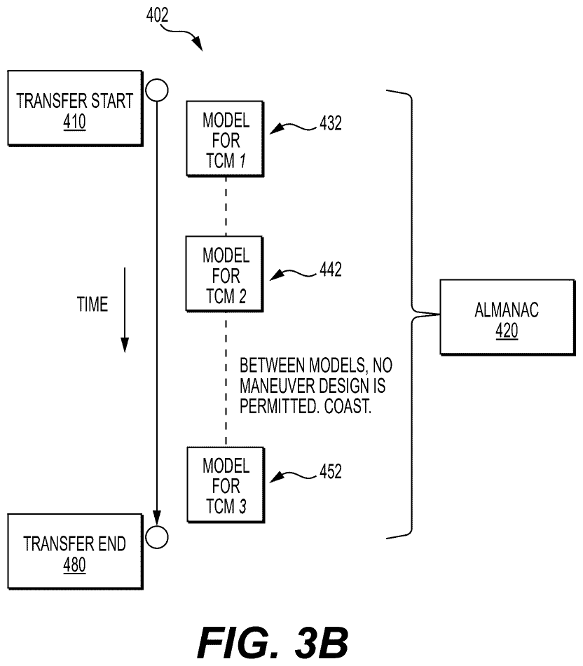

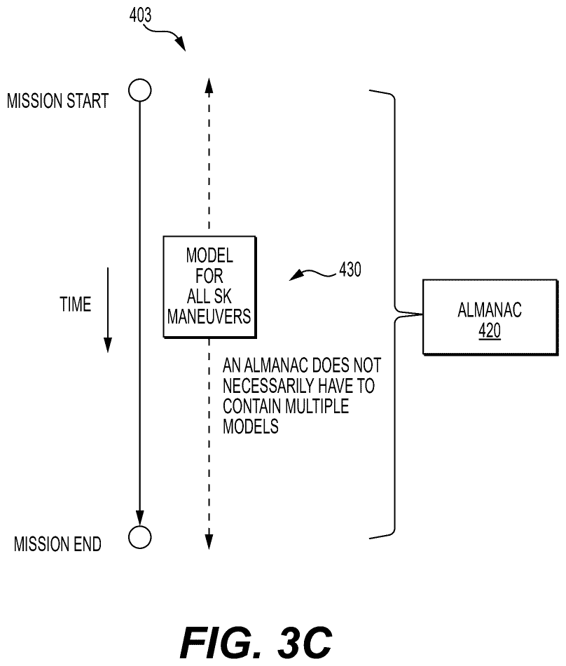

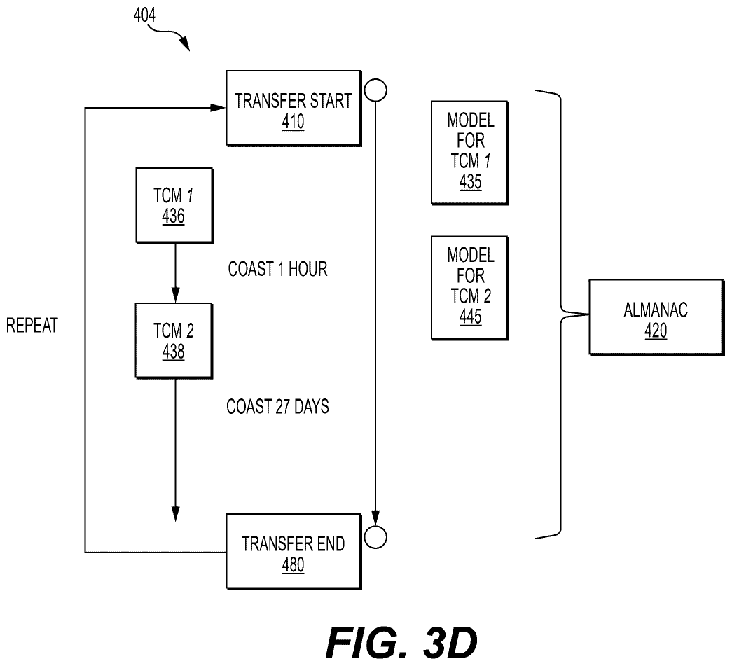

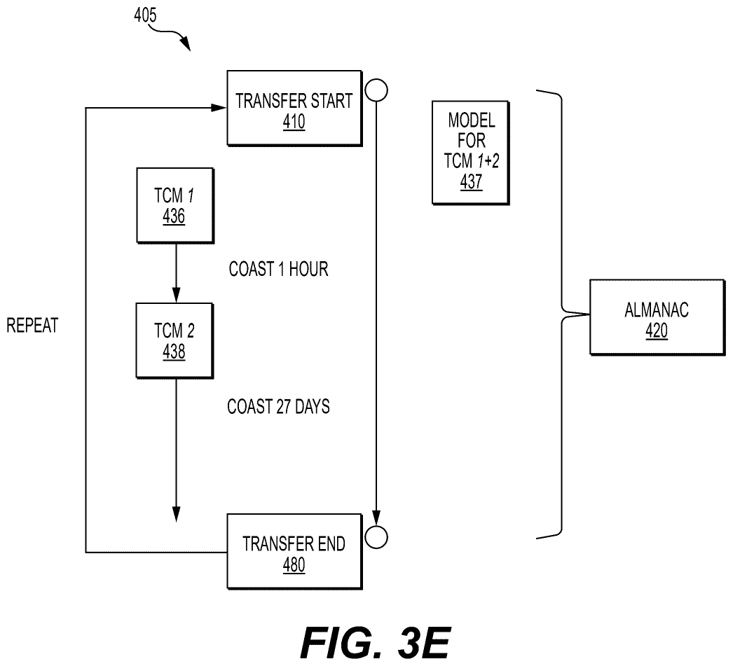

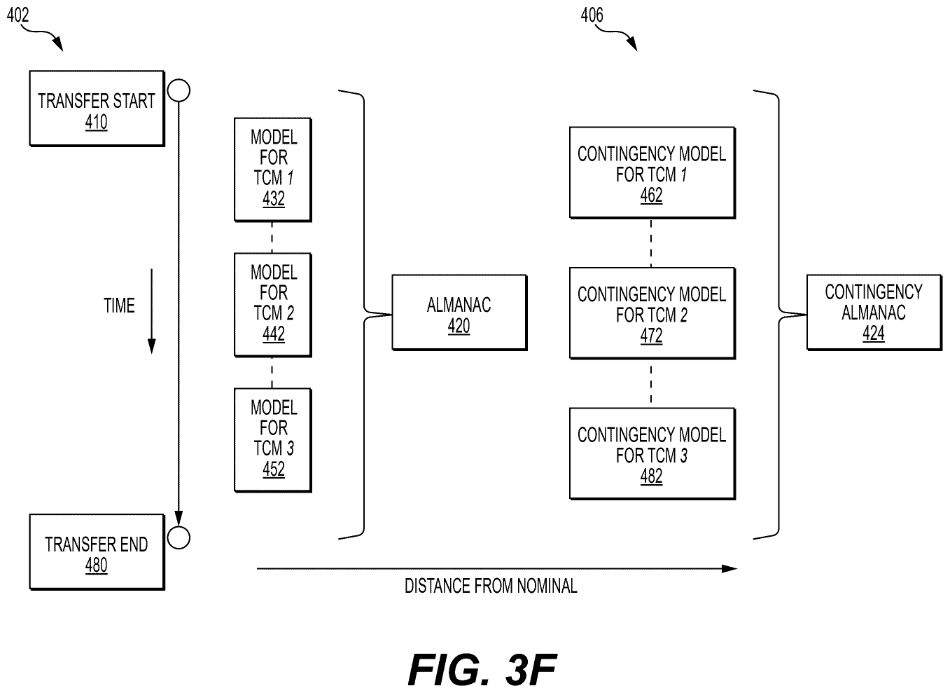

FIG. 3A shows a time-ordered almanac method 400 from transfer start 410 to transfer end 480. The almanac method 400 contains a “n” number of time-based neural network models from model-1 430, to model-n 470, and ancillary information (not shown). The almanac structure's ancillary information maps each neural network model to its corresponding epoch range and stores parameters used when simulating NNEP control. Each neural network model is responsible for only a section of the nominal transfer operation. Experience has suggested this often produces better results than attempting to train one neural network over an entire transfer. Typically, each neural network is trained for an epoch range in the transfer. In embodiments, the separate neural networks may be trained for different objectives. In the FIG. 3A embodiment, the epoch ranges of individual NN models overlap in order to provide continuous thrust with no coasting during the transfer. In methods 400, 402, 403, 404, 405, and 406, the ground system saves the entire almanac as a binary file which is read and parsed by the OLTAIR app onboard the spacecraft.

FIG. 3B shows one possible embodiment of a time-ordered almanac method 402 from transfer start 410 to transfer end 480. The almanac method 402 contains an almanac 420 containing three time-based neural network models used for trajectory correction maneuvers (TCM) required for the transfer: a first TCM-1 model 432, a second TCM-2 model 442, a third TCM-3 model 452, and ancillary information (not shown). Each neural network model is trained on the ground using tens of thousands of optimal trajectories. Each neural network model is responsible for only a section of the nominal transfer operation, with no maneuver design permitted between model epochs. During the time between neural network model TCMs, the spacecraft will coast. For example, each maneuver may last a few seconds or a minute, but the overall trajectory from transfer start 410 to transfer end 480 may last much longer (e.g., six months).

FIG. 3C shows another embodiment of a method 403 for autonomous neural network control for spacecraft navigation from a mission start to a mission end using a single-model almanac. An almanac does not necessarily contain multiple models. In method 403, almanac 420 contains only a single NN model 430 in which one or more thrust commands are provided for one or more maneuvers. Almanac 420 may be configured to provide an NN model and any ancillary information, such as the model's valid operational lifetime, for one or more thrust commands. For certain spacecraft missions, simpler maneuver correction problems may be covered using a single, small NN model, with the advantage of having low memory and low computational costs. FIG. 3E, described below, provides a specific example of a spacecraft navigation mission that uses a single-model almanac.

FIG. 3D shows another embodiment of a time-ordered almanac method 404. The almanac method 402 contains an almanac 420 containing paired time-based neural network models used for paired trajectory correction maneuvers (TCM): model 435 for a first TCM-1 436 and model 445 for a second TCM-2 438, each with ancillary information (not shown). Between paired maneuvers TCM-1 436 and TCM-2 438, the spacecraft coasts for a shorter duration (e.g., on the order of hours). Following TCM-2 438, the spacecraft coasts for a longer duration (e.g., on the order of days), then the method 404 repeats.

In an example of method 404, the paired correction maneuvers TCM-1 436 and TCM-2 438 are useful for station keeping in a low orbit around the moon. The orbit moves around over time due to gravitational effects from Earth, and the pattern of movements repeats in 27-day cycles. In operation, after each 27-day cycle, the current navigation state estimate is updated, the NN inference is run for the paired models 435 and 445, and new paired maneuvers TCM-1 436 and TCM-2 438 are outputted. TCM-1 436 is executed, the spacecraft coasts for the shorter duration (e.g., one hour), then TCM-2 438 is executed. The paired maneuvers reset the cycle of motion that the orbit makes. Following TCM-2 438, the spacecraft coasts for the longer duration (i.e., 27 days), then the transfer method 404 is repeated.

FIG. 3E shows another embodiment of a method 405 for autonomous neural network control for spacecraft navigation. Method 405 is an example of a single-model almanac method (like method 403 of FIG. 3C) that is capable of providing more than one thrust command for more than one maneuver (like method 404 of FIG. 3D). In method 405, the paired correction maneuvers TCM-1 436 and TCM-2 438, which are useful for station keeping in a low orbit around the moon for example, may receive thrust commands from a single model for both trajectory correction maneuvers (i.e., TCM 1+2 model 437). In operation, after each 27-day cycle, the current navigation state estimate is updated, the NN inference is run for the TCM 1+2 model 437, and new thrust commands for maneuvers TCM-1 436 and TCM-2 438 are both outputted. Just like with method 403 of FIG. 3D, TCM-1 436 is executed, the spacecraft coasts for the shorter duration (e.g., one hour), then TCM-2 438 is executed, and the paired maneuvers reset the cycle of motion that the orbit makes. Following TCM-2 438, the spacecraft coasts for the longer duration (i.e., 27 days), then the transfer method 405 is repeated.

FIG. 3F shows an embodiment that uses two time-ordered almanac methods in which time-ordered almanac method 402 from FIG. 3B is used with a second time-ordered almanac method 406. Method 402 includes almanac 420 which is a nominal almanac configured for trajectory correction maneuvers along a nominal trajectory (i.e., within a training tube of nominal trajectories used to train the NN models). Method 406 includes a contingency almanac 424 configured for trajectory correction maneuvers that will return the spacecraft to the nominal trajectory when deviated (i.e., when the spacecraft is outside of the training tube of nominal trajectories).

The almanacs 420, 424 may be organized by distance from a nominal trajectory. For example, as depicted in FIG. 3F, a contingency model for the first trajectory correction maneuver (TCM-1) 462 is configured for situations in which the spacecraft is outside the nominal trajectory; likewise, a contingency model for the second trajectory correction maneuver (TCM-2) 472, and, a contingency model for the third trajectory correction maneuver (TCM-3) 482 are also configured for situations in which the spacecraft is outside the training tube of nominal trajectories at different times in a navigation mission or transfer. Each of the contingency models are trained during ground operations for many (e.g., thousands) of potential deviations based on a range of distances from the nominal trajectory. When the navigation state of the spacecraft is updated, the appropriate contingency model may be looked up based on an amount of deviation of the current navigation state (e.g., position or velocity) from the expected nominal state.

The contingency models 462, 472, 482 are more robust to large errors, while the nominal models 432, 442, 452 are more accurate but only for a narrow region around a reference trajectory. In operation, following a navigation update, the software is programmed to select an appropriate almanac based on a state error range. For example, if a position error is less than 5,000-km, the nominal almanac 420 may be selected; if the position error is greater than or equal to 5,000-km but less than 10,000-km, the contingency almanac 424 may be selected; and if the position error is greater than or equal to 10,000-km, a second contingency almanac (not shown) may be selected.

A series of almanacs organized by distance from nominal may be used consecutively as the spacecraft is incrementally returned towards the nominal trajectory. After the spacecraft position is returned to the nominal trajectory, the appropriate time-ordered nominal model may then be selected. In the FIG. 3F example, three contingency models 462, 472, 482 are shown but additional models may be included in contingency almanac 424; likewise, two almanacs 420, 424 are shown but additional almanacs that are ordered based on distance from nominal may be employed without departing from the scope hereof.

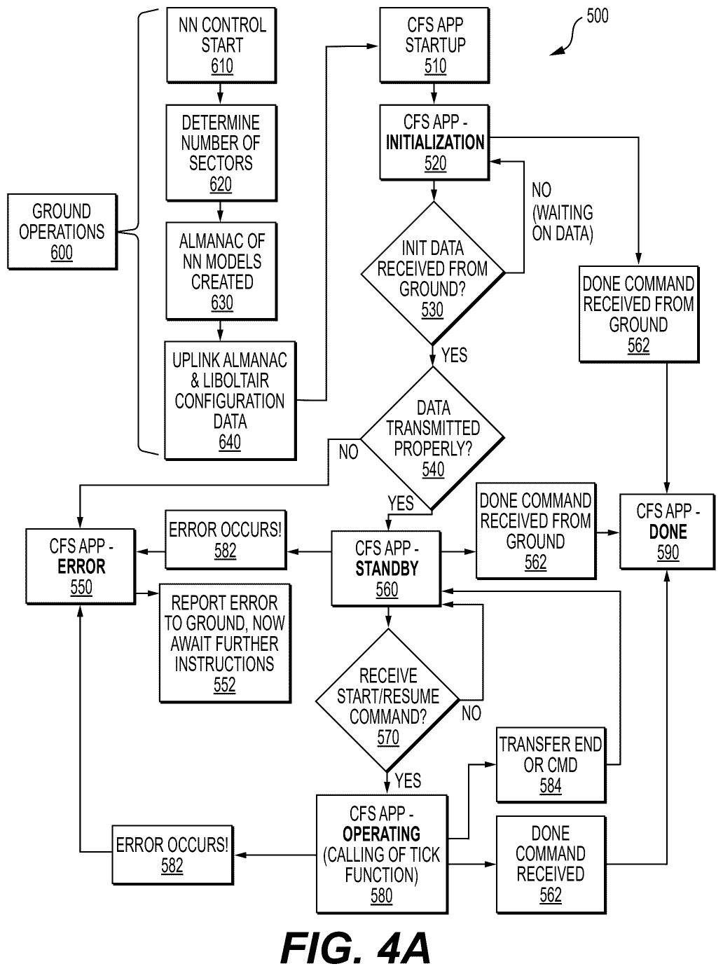

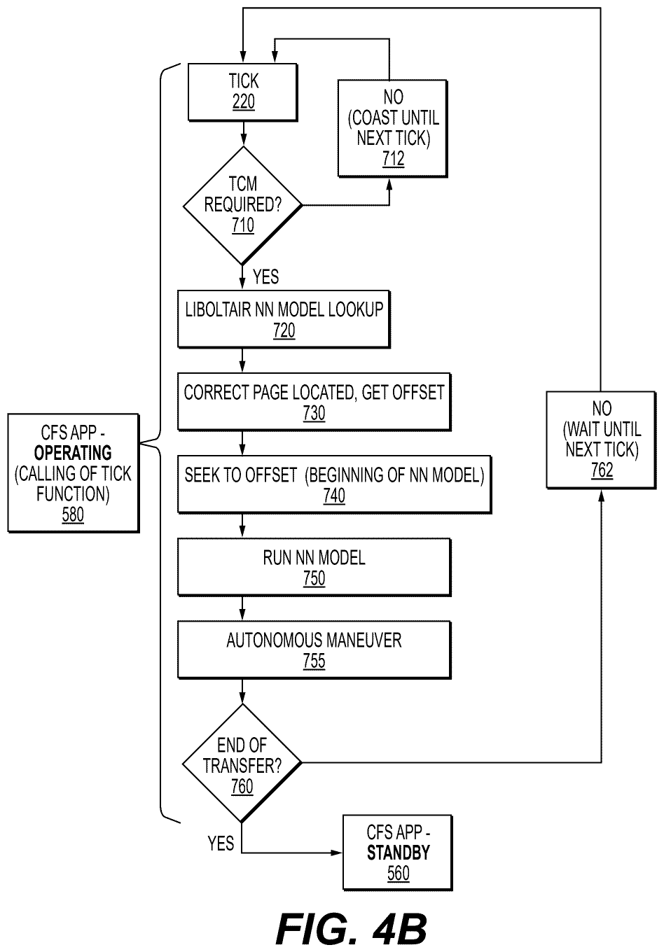

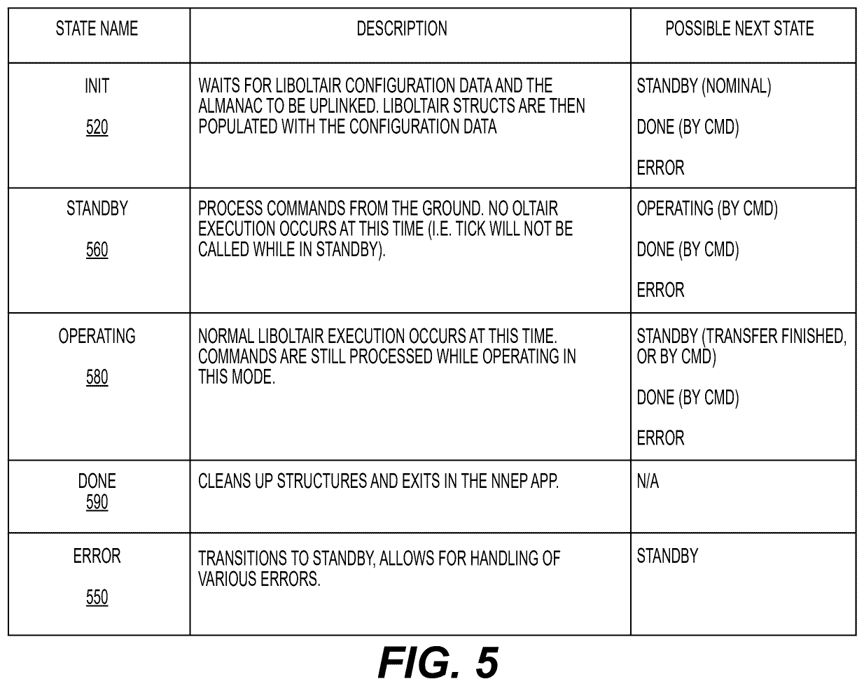

FIG. 4A is an exemplary autonomous neural network control transfer method 500. Method 500 may be carried out using the NNEP cFS application (described above) running onboard the spacecraft. In embodiments, the NNEP application is implemented as a state machine. FIG. 5 shows a table of the different NNEP cFS application states. FIGS. 4A and 5 are best viewed together with the following description.

Prior to the transfer method 500, ground operations 600 are performed, which includes steps 610, 620, 630, and 640. In step 610, a reference (e.g., nominal) trajectory is determined. In step 620, the appropriate n number of sectors necessary for the nominal transfer or navigation operation is determined. An almanac of n number of NN time-based models and ancillary Liboltair configuration data is then created in a step 630, and uplinked to the spacecraft in a step 640. In an example of step 630, the almanac of n NN time-based models is almanac 420 described above in connection with FIG. 3B.

In a step 510, the NNEP cFS application is started onboard a spacecraft. In a step 520, the cFS app enters an initialization state where the app waits until the Liboltair configuration data and the almanac have completed being uplinked from the ground in step 640. In a step 530, if no initialization data are received from step 640, the application loops and further waits in the initialization state. Once initialization data are received from the ground, the cFS app checks if the data were transmitted properly in a step 540. Upon successful transmission of initialization data, Liboltair data structures (i.e., structs) are populated with the configuration data and the app enters a standby state in a step 560. If an error occurs in a step 582 such that the transmission of initialization data is not successful, the app enters an error state in a step 550 in which the app reports the error to ground control, and awaits further instructions in a step 552. Once the cFS app proceeds to the standby state in a step 560, the app awaits process commands from ground control. No OLTAIR execution occurs at this time (i.e., a tick will not be called while in standby).

While the cFS app is in the standby state in step 560, there are three possible next app states. In a step 590, cFS app may enter a done state after receiving a done command from ground control via a step 562. In a step 590, while in the done state, the app cleans up structures and exits the NNEP cFS app. cFS app may also enter the error state in a step 550 if an error occurs 582, the app then reports the error to ground, and awaits further instructions in a step 552. Finally, the app may enter an operating state in a step 580 if a start/resume command is received (e.g., by ground control) in a step 570. Normal Liboltair execution occurs at this time. Step 580 is described in further detail below in connection with FIG. 4B. If no start/resume command is received in step 570, the cFS app returns to the standby state in step 560. Commands from ground control are still processed while the cFS app is in the operating state in the step 580. The cFS app may return to the standby state in two ways in a step 584: 1) upon the successful completion of a nominal transfer; and, 2) after receiving a command to return to the standby state from ground control.

FIG. 4B shows sub-steps of step 580 from FIG. 4A. In step 580, the cFS app is in the operating state. In an example of step 580, the cFS app calls a tick function (e.g., navigation tick 220 of FIG. 2). Following navigation tick 220, the onboard computer determines if a TCM is required in a step 710. If the spacecraft is on a nominal trajectory, no TCM is required and the spacecraft will coast until the next tick in a step 712.

In a step 710, the onboard computer may determine that a TCM is required. In an example of step 710, a computer onboard the spacecraft determines a state of the spacecraft (e.g., position, direction, and velocity of the spacecraft) and compares the current state against a nominal planned state. If the current state is outside a predetermined range of nominal, then a TCM will be required.

In a step 720, Liboltair looks up information for a given NN model. In an example of step 720, Liboltair accesses the almanac and looks up the weights and biases of a NN model (as a function of time) for the specific epoch of the spacecraft by searching an ordered list of page objects which are stored immediately after the almanac header. In another example of step 720, the navigation state is checked to ensure any state error is less than a predetermined threshold; if the state error is less than the threshold, the nominal almanac 420 of FIG. 3F is used; if the state error is greater than the threshold, the contingency almanac 424 of FIG. 3F is used instead.

In a step 730, the onboard computer locates the correct page, and stores an offset location specified in the page. The offset location is for example a beginning of a pre-trained mission-specific NN model for the current epoch.

Once the correct page has been located and the offset stored, the onboard computer seeks to the offset location specified in the page in a step 740, where the offset location corresponds to the beginning of a pre-trained mission-specific NN model for the current epoch. In an example of step 750, the NN model is prefixed by a model header which indicates how many NN layers are found in the model, and NN layers are stored immediately after the model header. Each NN layer begins with a layer header which is then followed by the appropriate number of parameters (e.g., weights and/or biases) stored as doubles. In some embodiments, a parameter matrix is stored in memory of the onboard computer as a weight matrix which is augmented with a vector of biases.

In a step 750, the onboard computer runs the pre-trained NN model selected in the step 740. In an example of step 750, the spacecraft can update the thruster commands immediately for a critical operation compared to traditional human-in-the-loop control update which is historically on the order of days and requires 24-hour coverage from the operations team on the ground. The speed of the control loop onboard the spacecraft is limited only by the onboard navigation requirements.

In a step 755, the spacecraft performs an autonomous maneuver based on the NN model that was run in step 750. In an example of step 755, a TCM is performed by the spacecraft for the given pre-determined epoch.

In a step 760, following the TCM, the onboard computer determines if the previous tick was the final tick in the transfer or other navigation operation. If the previous tick was the final tick in the transfer, the transfer is complete and the cFS application returns to the standby state in step 560 of FIG. 4A. If the previous tick was not the final tick, the spacecraft will coast and the cFS application waits in a step 762 until the next tick 220 where the onboard computer may repeat the process.

FIG. 5 provides a description for each state and lists the possible next states as shown above in FIGS. 4A and 4B. For example, from the initialization state in step 520, there are three possible next states: 1) in nominal operations after a successful uplink of data, the cFS application may proceed to the standby state in step 560; 2) the cFS application may enter the done state in step 590 via ground command from step 562; and, 3) the cFS application may proceed to the error state in step 550 if an error occurs.

From the standby state in step 560, there are three possible next states: 1) the cFS application may proceed to the operating state in step 580 by receiving a start/resume command from ground in step 570; 2) the cFS application may enter the done state in step 590 via ground command in the step 562; 3) the cFS application may proceed to the error state in step 550 if an error occurs.

From the operating state in step 580, there are three possible next states: 1) the cFS application may revert back to the standby state in step 560, either by receiving a command from ground or upon successful completion of a transfer in step 584; 2) the cFS application may enter the done state in a step 590 by ground command in the step 562; 3) the cFS application may proceed to the error state in step 550 if an error occurs.

No next possible states may be reached from the done state 590. From the error state 550, the standby state may be reached following error correction.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An almanac method for autonomous neural network navigation of a spacecraft, the method comprising:
providing autonomous neural network navigation of the spacecraft by performing steps via
a computer onboard the spacecraft, the steps comprising:
determining a current navigation state of the spacecraft;
determining a current target epoch for the spacecraft based on the current navigation state;
reading neural network model parameters from an almanac for the current target epoch, wherein the almanac contains a plurality of neural network models each valid for an epoch corresponding to a portion of a trajectory; and
executing a neural network model of the plurality corresponding to the current target epoch to provide one or more thrust commands for the spacecraft.

2. The almanac method of claim 1, wherein the epoch corresponding to each of the neural network models overlaps with at least one neighboring epoch to provide continuous neural network navigational control throughout the trajectory.

3. The almanac method of claim 2, wherein neural network navigational control comprises continuous thrust across a plurality of epochs with no coasting.

4. The almanac method of claim 1, wherein the epochs corresponding to the neural network models do not overlap such that no thrust commands are provided between epochs and the spacecraft coasts between epochs.

5. The almanac method of claim 1, wherein the almanac comprises a pair of time-based neural network models configured for use with paired trajectory correction maneuvers.

6. The almanac method of claim 1, comprising reading neural network model parameters from a second almanac, wherein the second almanac comprises a plurality of neural network models for contingency maneuvers in which the spacecraft has deviated substantially from a nominal trajectory, the contingency maneuvers being configured to return the spacecraft to the nominal trajectory.

7. The almanac method of claim 6, wherein when the spacecraft has deviated substantially from the nominal trajectory, an appropriate contingency model is looked up based on an amount of deviation of the current navigation state from an expected nominal state.

8. The almanac method of claim 6, wherein the neural network models for contingency maneuvers are more robust to large errors but less accurate compared to nominal neural network models.

9. A method for autonomous neural network navigation of a spacecraft, the method comprising:
performing autonomous navigational steps via a computer onboard the spacecraft, the steps comprising:
reading neural network model parameters from an almanac containing at least one neural network model, wherein each neural network model is valid for an epoch corresponding to a portion of a trajectory;
determining a current navigation state of the spacecraft;
determining a current target epoch for the spacecraft based on the current navigation state; and
executing the neural network model corresponding to the current target epoch to provide one or more thrust commands for the spacecraft.

10. The method of claim 9, wherein the at least one neural network model is configured to provide continuous neural network navigational control throughout the entire trajectory.

11. The method of claim 9, wherein the almanac comprises a pair of time-based neural network models configured for use with paired trajectory correction maneuvers.

12. The method of claim 9, comprising reading neural network model parameters from a second almanac, wherein the second almanac comprises a plurality of neural network models for contingency maneuvers in which the spacecraft has deviated substantially from a nominal trajectory, the contingency maneuvers being configured to return the spacecraft to the nominal trajectory.

13. The method of claim 12, wherein when the spacecraft has deviated substantially from the nominal trajectory, an appropriate contingency model is looked up based on an amount of deviation of the current navigation state from an expected nominal state.

14. The method of claim 13, wherein the neural network models for contingency maneuvers are more robust to large errors but less accurate compared to nominal neural network models.

15. The method of claim 9, wherein the at least one neural network model comprises a single neural network model configured to provide autonomous spacecraft navigation from a mission start to a mission end.

16. The method of claim 15, wherein the single neural network model comprises one or more thrust commands configured for providing one or more spacecraft maneuvers.

17. A computer program product for autonomous neural network navigation of a spacecraft, the computer program product comprising a computer readable storage medium having computer readable instructions stored therein, wherein the computer readable instructions, when executed on a computing device, causes the computing device to:
read neural network model parameters from an almanac containing at least one neural network model, wherein each neural network model is valid for an epoch corresponding to a portion of a trajectory;
determine a current navigation state of the spacecraft;
determine a current target epoch for the spacecraft based on the current navigation state; and
execute the neural network model corresponding to the current target epoch to provide one or more thrust commands for the spacecraft.

18. The computer program product of claim 17, wherein the at least one neural network model is configured to provide continuous neural network navigational control throughout the entire trajectory.

19. The computer program product of claim 17, wherein the computer readable instructions are configured to read neural network model parameters from a second almanac, wherein the second almanac comprises a plurality of neural network models for contingency maneuvers in which the spacecraft has deviated substantially from a nominal trajectory, the contingency maneuvers being configured to return the spacecraft to the nominal trajectory.

20. The computer program product of claim 19, wherein when the spacecraft has deviated substantially from the nominal trajectory, an appropriate contingency model is looked up based on an amount of deviation of the current navigation state from an expected nominal state.
